(19) United States
(12) Patent Application Publication
(10) Pub. No.: US 2009/0146043 A1
(43) Pub. Date: Jun. 11, 2009

(54) MODULAR FORM FOR CASTING CONCRETE HIGHWAY BARRIERS

(75) Inventor: H. Gordon Gates, Denver, CO (US)

Correspondence Address: DORR, CARSON & BIRNEY, P.C.;ONE CHERRY CENTER, 501 SOUTH CHERRY STREET, SUITE 800, DENVER, CO, 80246, US

(73) Assignee: GATES & SONS, INC., Denver, CO (US)

(21) Appl. No.: 11/952,505

(22) Filed: Dec. 7, 2007

(51) Int. Cl. B28B 7/00; B28B 7/24; B28B 7/26; B28B 7/34; B41D 3/06

(52) U.S. Cl. 249/103; 249/126; 249/169

(57) ABSTRACT

A modular form has stackable upper and lower forms for casting concrete highway barriers. The lower form has opposing lower faces spaced apart to define a lower mold cavity, ties removably extending through the lower faces and lower mold cavity, and attachment angles extending along the top edges of the lower faces. The upper form has opposing upper faces spaced apart to define an upper mold cavity, ties removably extending through the upper faces and upper mold cavity, and attachment angles extending along the bottom edges of the upper faces. After the upper form has been stacked atop the lower form, fasteners are employed to removably secure the attachment angles of the lower form to those of the upper form. Thus, the upper and lower mold cavities are vertically aligned to create a combined cavity for forming a concrete highway barrier.

### BACKGROUND OF THE INVENTION

1. Field of the Invention

The present invention relates generally to the field of forms for casting concrete. More specifically, the present invention discloses a modular form for casting concrete highway barriers of various heights and cross-sections.

2. Statement of the Problem

A wide variety of forms have been used for many years in casting concrete highway median barriers. Many forms are intended to cast barriers off-site as a series of discrete sections that are then transported to the highway construction site for placement and assembly. This is sometimes referred to as precast construction. Some precast molding systems for concrete barriers incorporate removable or adjustable faces to alter the cross-sectional shape or size of the mold cavity. Precast molding has the advantage of economies of scale in being able to produce a large number of standardized barrier sections at a central facility. However, the barrier sections must then be transported to the construction site and assembled.

In contrast, on-site casting involves molding concrete barriers in place at the construction site. This is conventionally done by erecting a number of molds at the construction site, pouring concrete into the molds, and then disassembling the molds after a period of time to reveal the finished concrete barrier. Forms for on-site casting of concrete barrier have long been commercially available in a number of standard heights, dimensions and cross-sectional shapes. Customized forms have also been used. These are often constructed on an ad hoc basis to meet the specific requirements of a particular job, and then disassembled or discarded after the job has been completed. Another prior-art approach has been to cast highway barriers of a standard height on-site and then erect a superstructure above the barriers, either by stacking additional barriers atop the initial barriers, or by masonry construction atop the initial barriers. However, a need exists for a modular concrete form that can be quickly and easily adapted to mold concrete highway barriers having a wide range of heights or cross-sections.

3. Solution to the Problem

The present invention addresses the shortcomings of the prior art in the field of modular forms for on-site casting by employing stackable segments that can be combined to create a form for concrete highway barriers of a desired height. In addition, the mold faces can be readily replaced or repositioned relative to one another to configure the form to create barriers of a desired cross-section.

### SUMMARY OF THE INVENTION

This invention provides a modular form having stackable upper and lower forms for casting concrete highway barriers. The lower form has opposing lower faces spaced apart to define a lower mold cavity, ties removably extending through the lower faces and lower mold cavity, and attachment angles extending along the top edges of the lower faces. The upper form has opposing upper faces spaced apart to define an upper mold cavity, ties removably extending through the upper faces and upper mold cavity, and attachment angles extending along the bottom edges of the upper faces. After the upper form has been stacked atop the lower form, fasteners are employed to removably secure the attachment angles of the lower form to those of the upper form. Thus, the upper and lower mold cavities are vertically aligned to create a combined cavity for forming a concrete highway barrier. In addition, sets of forms can be combined in series to create a mold cavity of any desired length by fastening together the lateral attachment angles extending along the lateral edges of the forms.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a perspective view of an assembled form embodying the present invention.

FIG. 2 is an exploded perspective view of the form corresponding to FIG. 1.

FIG. 3 is a vertical cross-sectional view of the upper form 10.

FIG. 3a is a side elevational view showing an embodiment of the upper and lower forms 10, 20 with form liners 12, 22.

FIG. 4 is a vertical cross-sectional view of the lower form 20.

FIG. 5 is a vertical cross-sectional view of another embodiment of the lower form 20.

FIG. 6 is a side elevational view of the upper form 10.

FIG. 7 is a top plan view of the upper form 10

FIG. 8 is a side elevational view of the lower form 20.

FIG. 9 is a detail perspective view showing two sets of forms being attached to one another in series.

FIG. 10 is a detail perspective view showing a taper tie 40 being inserted through a form.

FIG. 10a is a detail perspective view corresponding to FIG. 10 after the taper tie 40 has been secured to the form by a side-lock 50.

FIGS. 11 and 12 are detail perspective views showing an upper form 10 being attached to a lower form 20 and secured by a fastener 30 and bolt 17.

FIG. 13 is a perspective view of a fastener 30 in the closed position.

FIG. 14 is a perspective view of a fastener 30 in the open position.

FIGS. 15 and 16 are detail perspective views taken from FIG. 9 showing the fastener 30 in its open position (FIG. 15) and closed position (FIG. 16) as the forms are brought together.

FIG. 17 is a detail perspective view showing the manner in which a taper tie 40 can be stowed on a form when not in use.

FIG. 18 is a perspective view of a finished concrete highway median barrier.

FIG. 19 is a vertical cross-sectional view of one embodiment of a concrete highway median barrier intended for use with roadbeds are two different elevations.

### DETAILED DESCRIPTION OF THE INVENTION

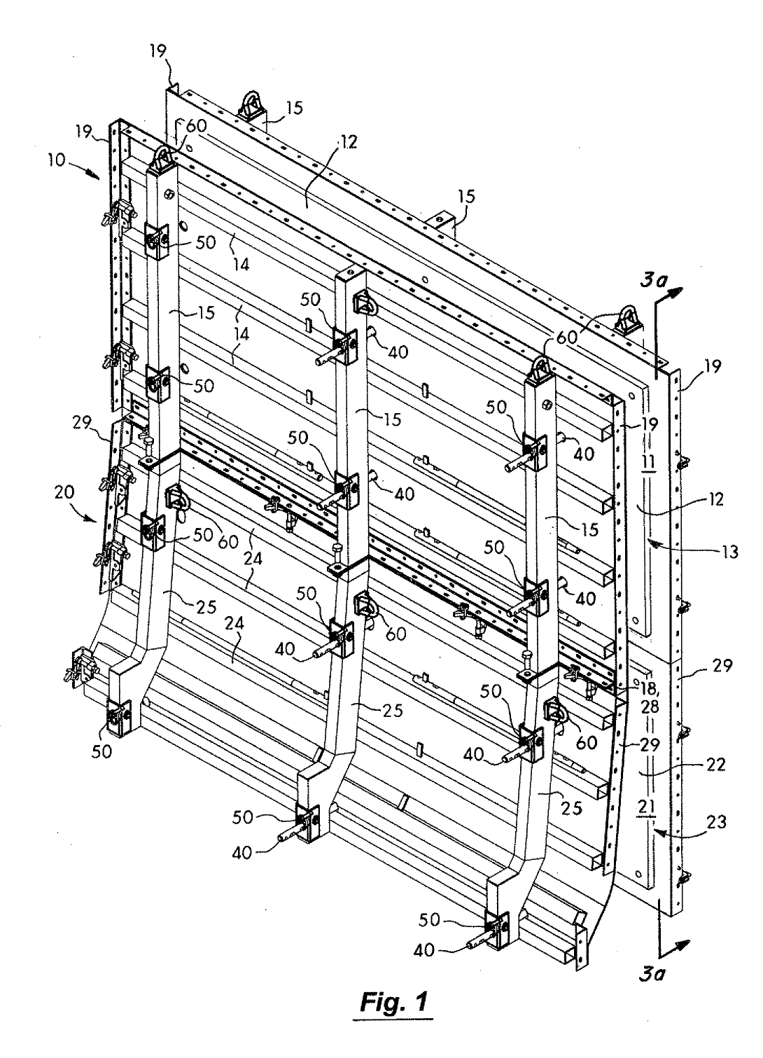

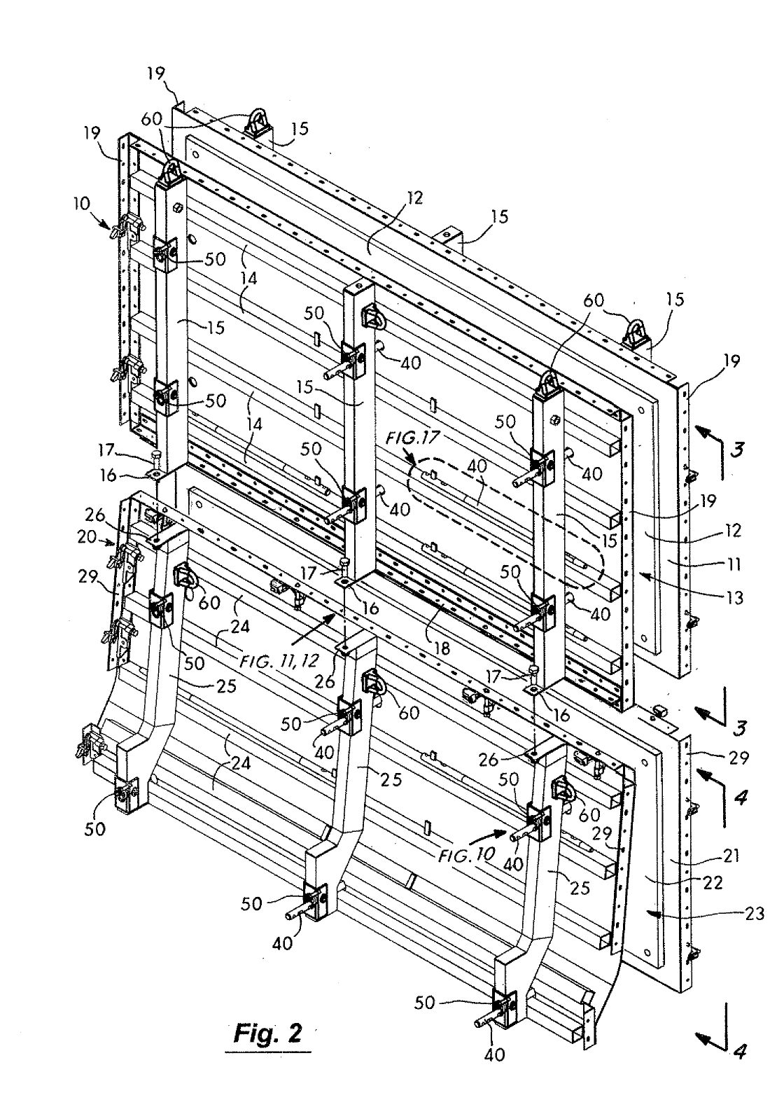

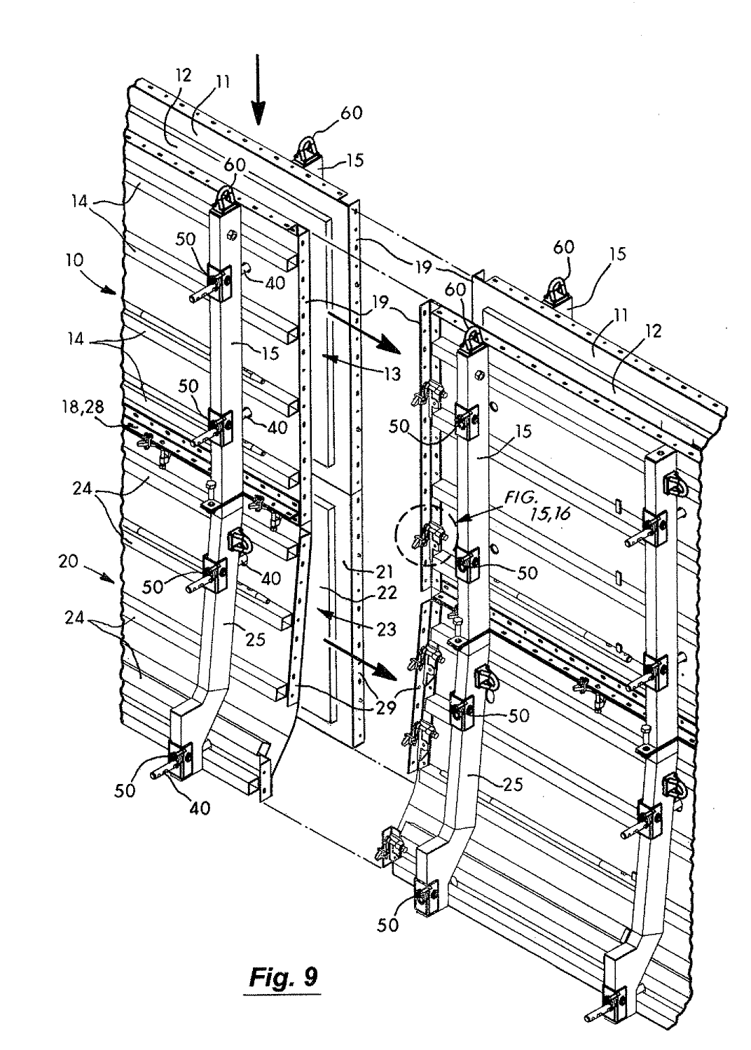

Turning to FIG. 1, a perspective view is provided of an assembled form embodying the present invention. FIG. 2 is an exploded perspective view corresponding to FIG. 1. As illustrated in FIG. 2, the major components are an upper form 10 that can stacked atop a lower form 20 to cast concrete barriers of a desired height. The faces of the forms 10, 20 can be readily replaced to cast concrete barriers of different dimensions and cross-sections. In addition, these forms 10, 20 can be attached to one another in series (i.e., in an end-to-end relationship), as shown in FIG. 9, to a cast concrete barrier of a desired length.

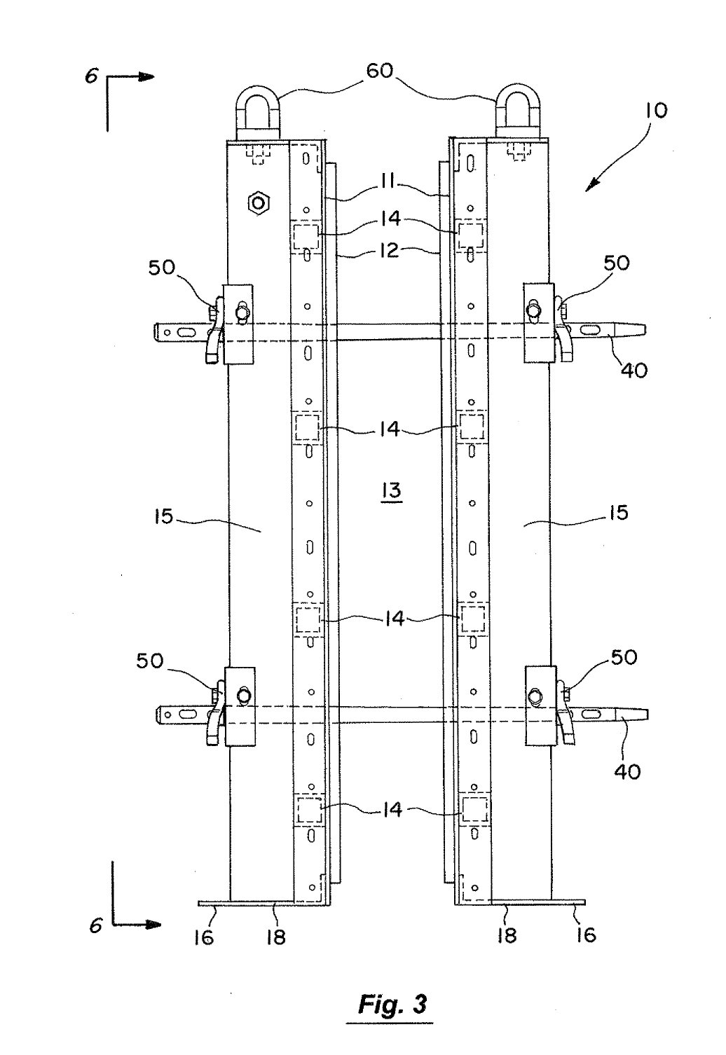

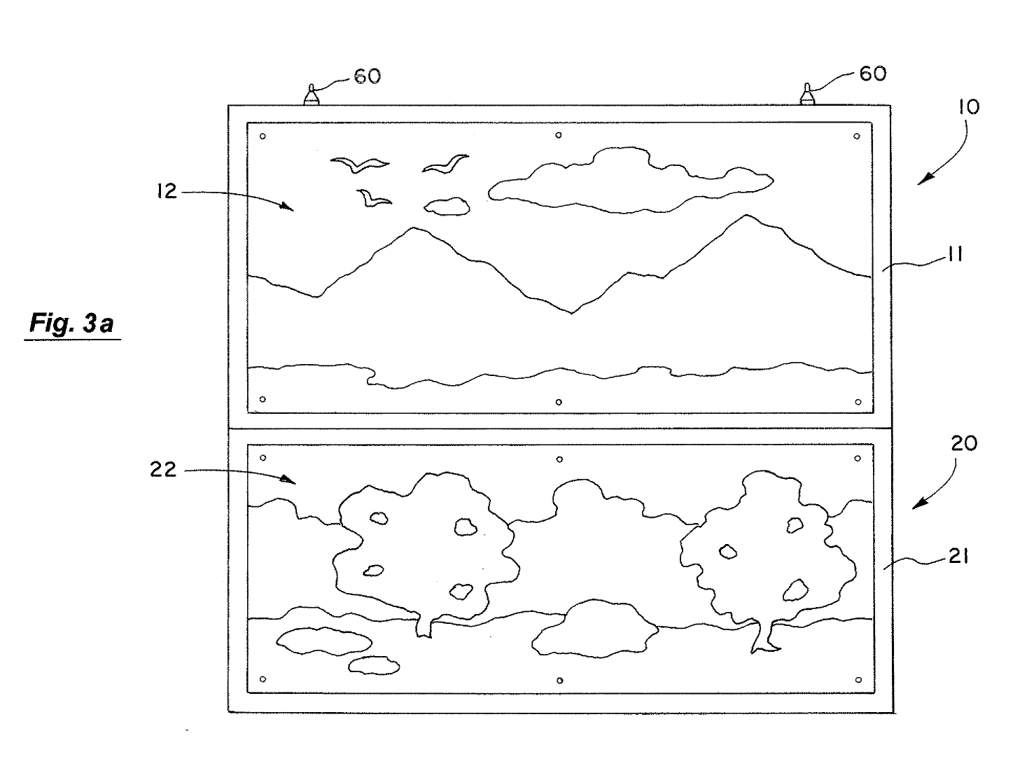

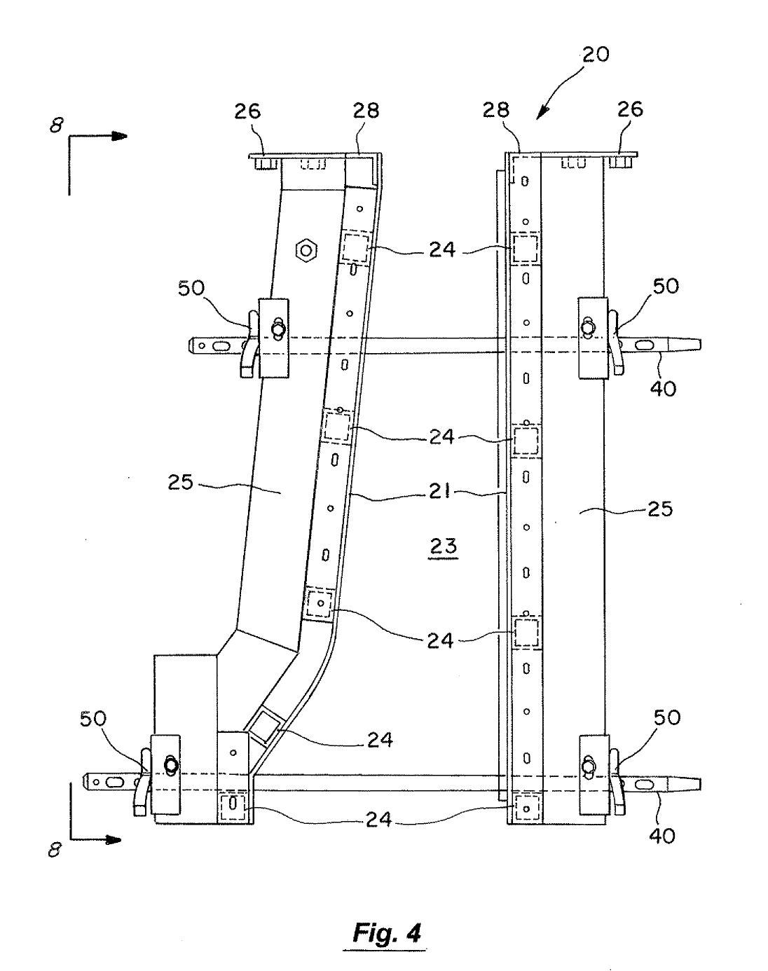

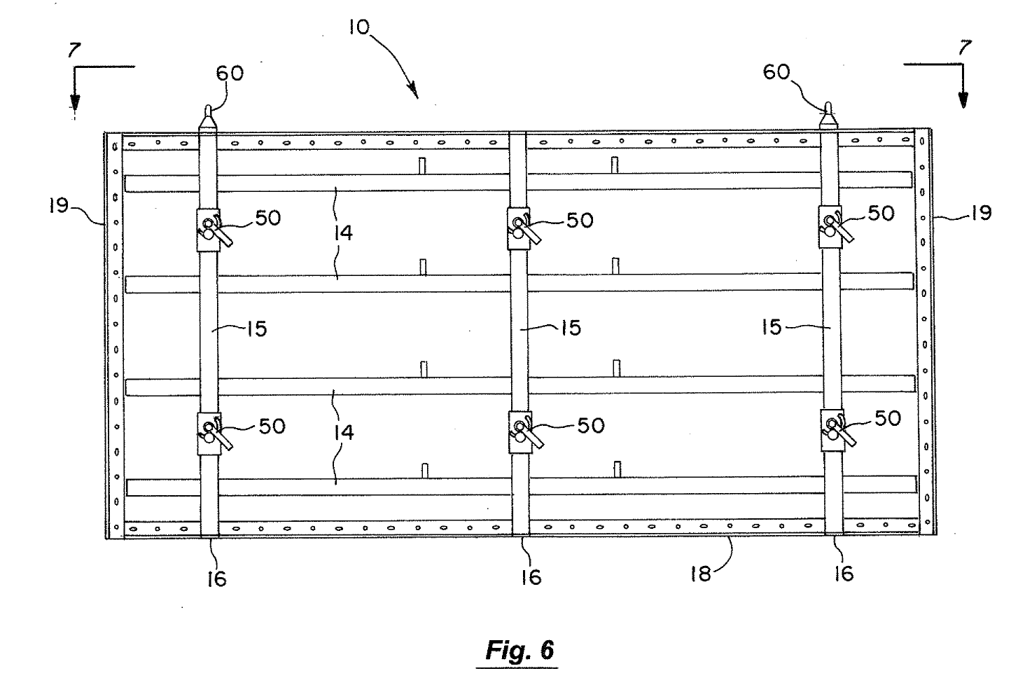

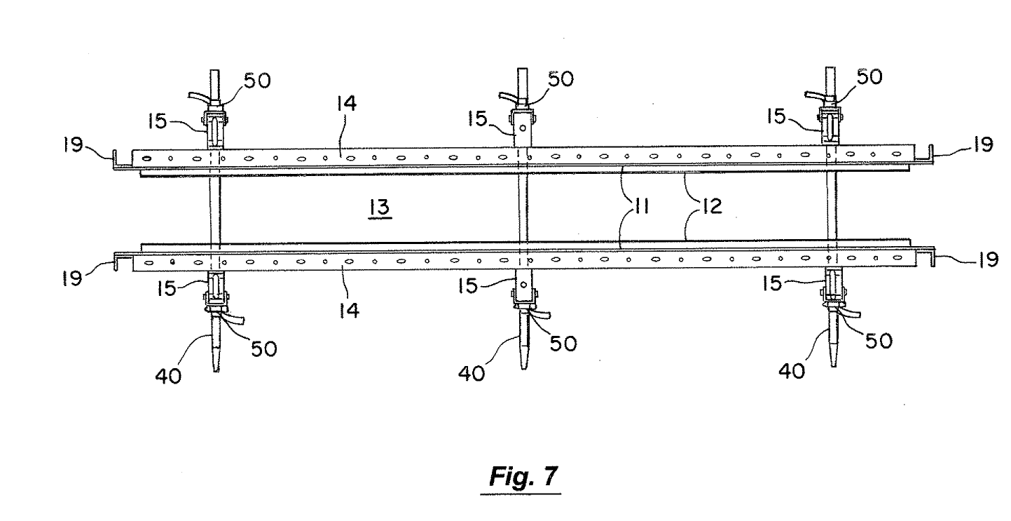

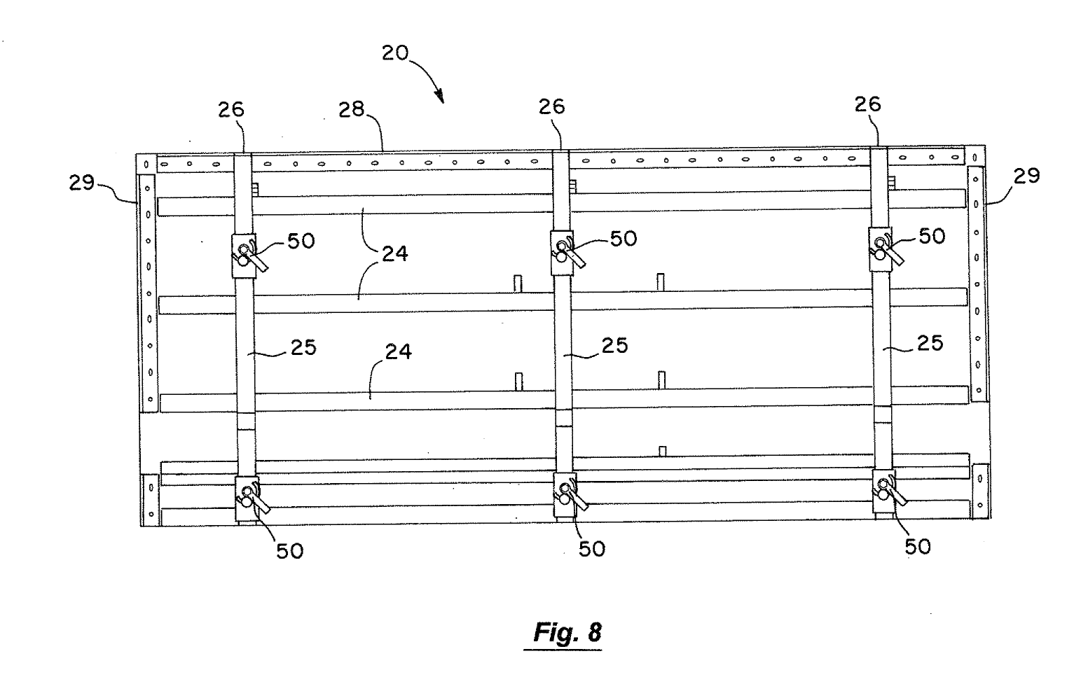

Vertical cross-sectional views of the upper and lower forms 10, 20 are depicted in FIGS. 3 and 4, respectively. Corresponding side elevational views of the upper and lower forms 10, 20 are illustrated in FIGS. 6 and 8, respectively. FIG. 7 is a top plan view of the upper form 10. The upper form 10 has two opposing upper faces 11, each having top, bottom and lateral edges. The upper faces 11 are spaced apart from one another to define an upper mold cavity 13. A number of vertical strongbacks 15 and horizontal walers 14 provide a support structure for each face 11 of the upper form 10. For example, the horizontal walers 14 can be welded at intervals to the outer surfaces of the upper faces 11, and the vertical strongbacks 15 can be welded at intervals across the walers 14 to create rigid orthogonal grids of reinforcing members for each upper face 11, as shown in FIGS. 1, 2 and 6. Thus, each upper face 11 with its walers 14 and strongbacks 15 constitutes an integral structure that can be transported as a unit and assembled as half of an upper form 10. A number of ties 40 removably extend through the strongbacks 15, upper faces 11 and upper mold cavity 13 to assemble two of these halves together. During assembly of the forms, removable ties 40 are inserted laterally through the strongbacks 15, upper faces 11 and upper mold cavity 13. These ties 40 are secured at both ends to the strongbacks 15 with side-locks 50 to hold the assembled upper form 10 together while a concrete barrier is being cast.

The lower form 20 has a generally similar structure. Here again, there are two opposing lower faces 21, each having top, bottom and lateral edges. The lower faces 21 are spaced apart from one another define a lower mold cavity 23. Vertical strongbacks 25 and horizontal walers 24 provide a support structure for the lower faces 21. During assembly of the lower form 20, removable ties 40 are inserted laterally through the strongbacks 25, lower faces 21 and lower mold cavity 23, and then secured to the strongbacks 25 with side-locks 50.

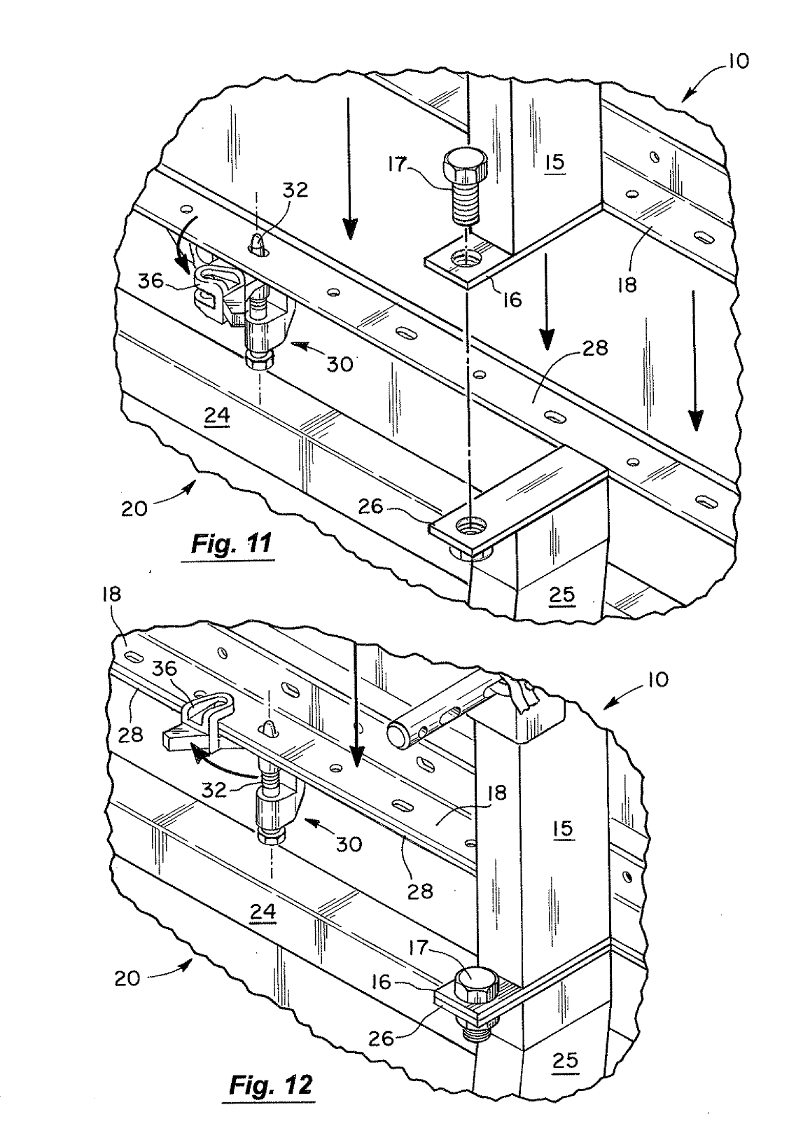

Attachment angles 18 run along at least a portion of the bottom edges of the upper faces 11. Similar attachment angles 28 run along at least a portion of the upper edges of the lower faces 21. When the upper form 10 is stacked atop the lower form 20, these attachment angles 18, 28 are vertically aligned and abut one another. A number of fasteners 30 can then be used to removably secure the attachment angles 18, 28 together, as depicted in FIGS. 11 and 12. This secures the upper form 10 to the lower form 20 with the upper mold cavity 13 vertically aligned above the lower mold cavity 23 to create a combined cavity suitable for forming a concrete barrier. In other words, the upper faces 11 of the upper form 10 are aligned above the lower faces 21 of the lower form 20. Preferably, the lower edges of the upper faces 11 abut the upper edges of the lower faces 21 after assembly to minimize the possibility of concrete leaking from the combined mold cavities 13, 23.

With the upper and lower forms 10, 20 in their stacked positions, the strongbacks 15, 25 are vertically aligned atop one another to provide structural support. The lower ends of the strongbacks 15 of the upper form 10 can be removably attached to the upper ends of the strongbacks 25 of the lower form 20. For example, the abutting ends of the strongbacks 15, 25 can be equipped with connecting flanges 16 and 26 that can be bolted 17 together as shown in FIGS. 11 and 12.

Lateral attachment angles 19, 29 extend along at least portions of the lateral edges of the upper and lower faces 11, 21. These allow a series of forms to be combined in series (i.e., in an end-to-end relationship) to create an assembly of any desired length. After two or more sets of forms have been positioned with their lateral attachment angles abutting one another, fasteners 30 are employed to removably secure the lateral attachment angles together.

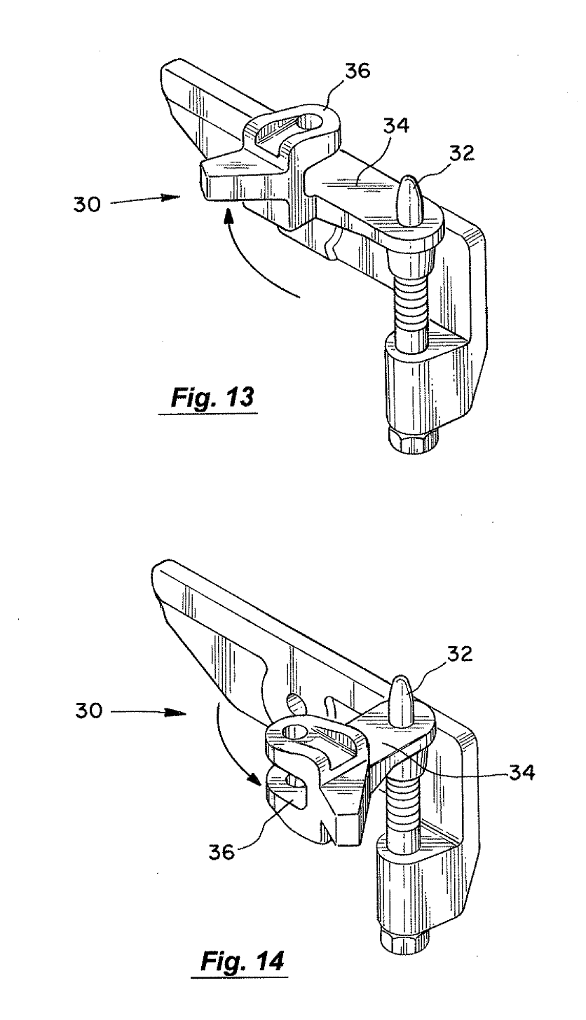

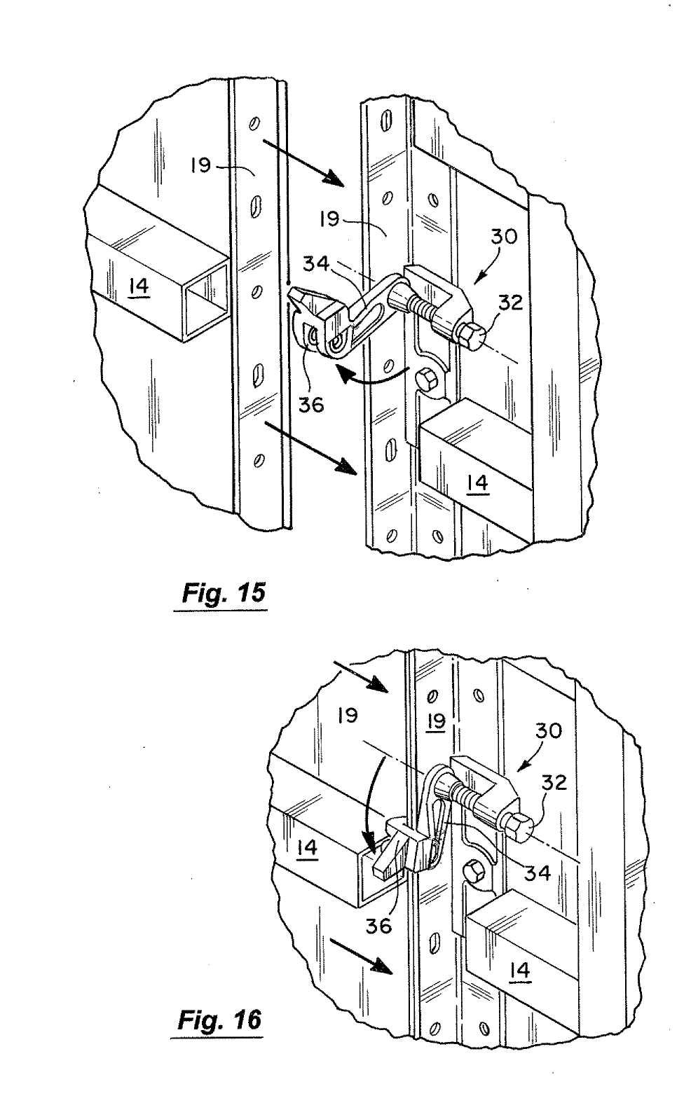

FIGS. 13-16 show one embodiment of the fastener 30 in greater detail. FIG. 13 is a perspective view of a fastener 30 in the closed position, and FIG. 14 shows the fastener 30 in the open position. FIGS. 15 and 16 are detail perspective views taken from FIG. 9 showing the fastener 30 in its open position (FIG. 15) and closed position (FIG. 16) as the forms are brought together. The exposed flanges of the attachment angles 18, 19, 28 and 29 are perforated with a holes are regular intervals. The anchor pin 32 of the fastener 30 is secured to one of these holes as shown in FIGS. 13 and 14. A pivot arm 34 extends from the anchor pin 32 and can freely pivot about the anchor pin 32 away from the flange of its attachment angle, A U-shaped clamp 36 on the distal end of the arm 34 grips the exposed edges of the attachment angles of the forms when the pivot arm 34 is rotated to the closed position shown in FIGS. 12, 13 and 16. The clamp 36 can also include an angled head to serve as a striking surface for a hammer or mallet to force the fastener into the closed position.

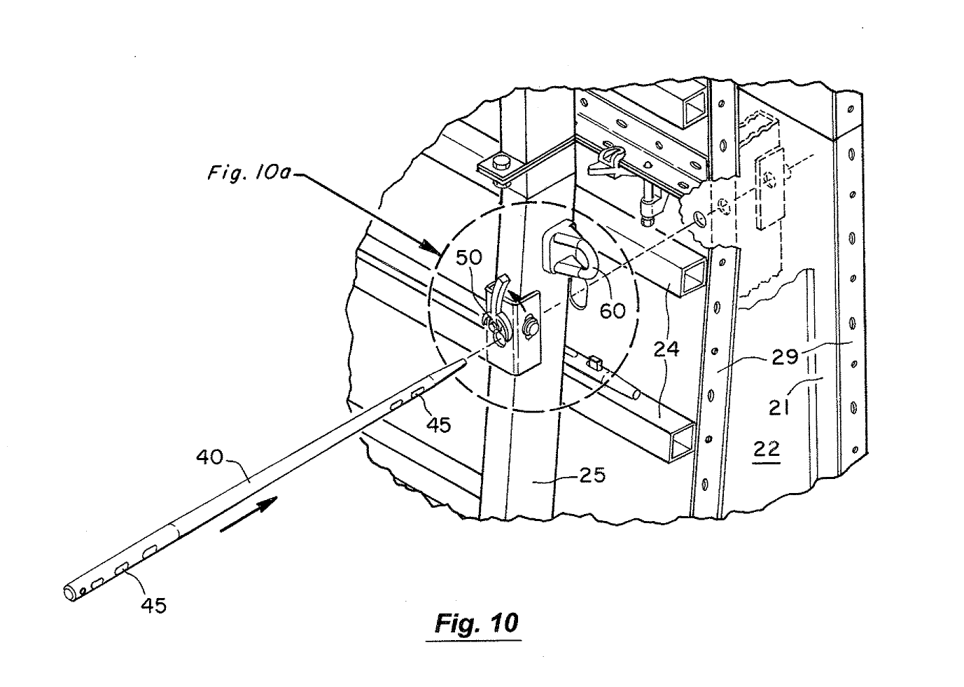

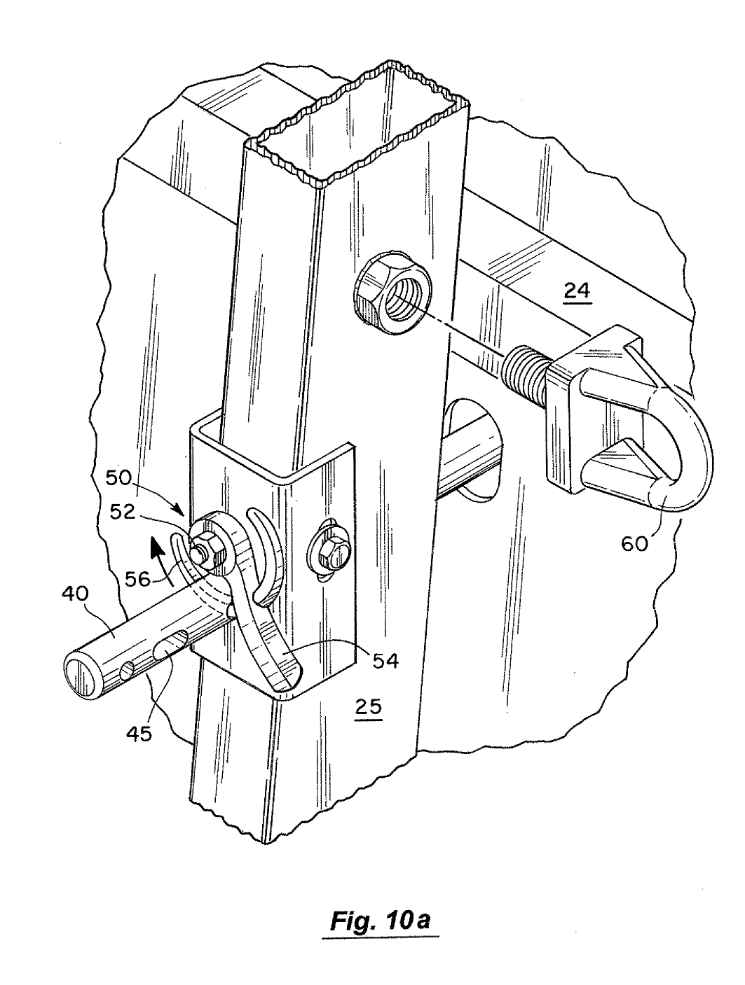

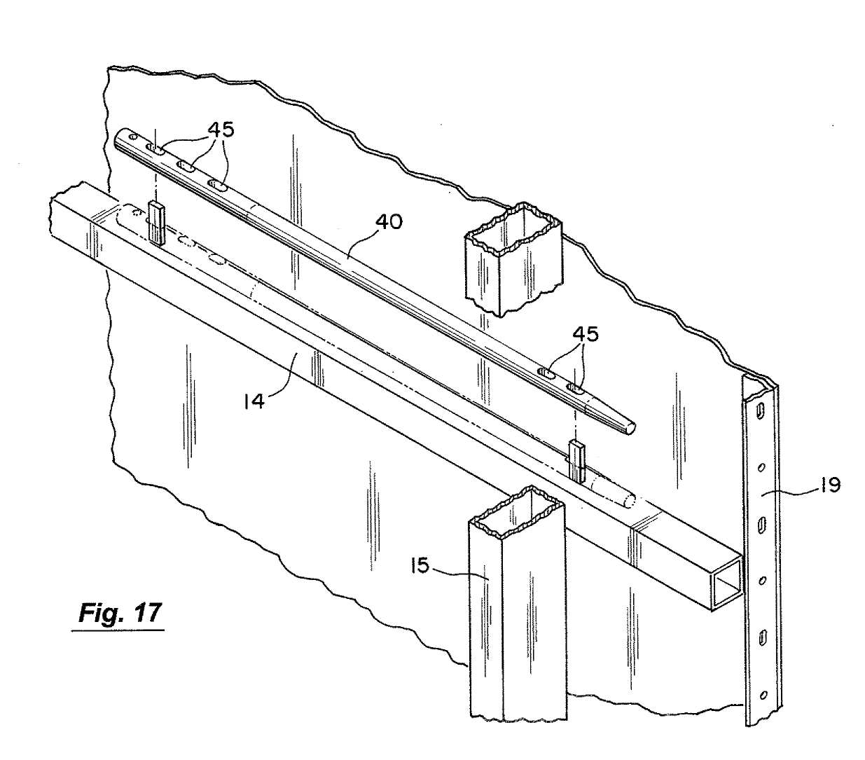

FIGS. 10, 10a and 17 provide additional detail of one embodiment of a taper tie 40. FIG. 10 is a detail perspective view showing a taper tie 40 being inserted through a form. These ties 40 essentially hold the opposing faces of the forms 10, 20 in a laterally-spaced relationship (i.e., with a desired spacing between the form faces). FIG. 10a is a detail perspective view after the taper tie 40 has been secured to the form by a side-lock 50. Each taper tie 40 is generally cylindrical, but has a slight axial taper to enable the tie 40 to be withdrawn from one side of a barrier after the concrete has set. The tapered cylindrical surface of the tie can be polished and plated with yellow chromate to further reduce friction with the concrete as the tie 40 is withdrawn. There is at least one hole 45 at each end of the tie 40 for receiving a side-lock 50 as shown in FIGS. 10 and 17. The axial distance between the holes 45 at the ends of a tie 40 are largely determined by the cross-sectional dimensions of the form cavity 13, 23, form faces 11, 21, and the supporting walers 14, 24 and strongbacks 15, 25. This axial distance between the holes 45 is designed so that side-locks 50 mounted on the strongbacks 15, 25 can engage and secure the holes 45 in the tie 40, as shown in FIG. 1-5, and thereby create a mold cavity with desired cross-sectional dimensions.

FIG. 10a is a detail perspective view of one embodiment of a side-lock 50. Each side-lock 50 has an anchor pin 52 mounted to a strongback 15, 25. An arcuate claw 56 is rotatably mounted to the anchor pin 52, and can be manually rotate by means of a handle 54. To lock a tie 40 in place, the tip of the claw 56 is advanced through a hole 45 in the tie 40 until the claw 56 is held in place by friction against the tie 40.

FIG. 17 is a detail perspective view showing the manner in which a taper tie 40 can be stowed on a form when not in use. In particular, sets of vertical pins or tabs extending upward from the walers engage the holes 45 in the tie 40 for storage when the tie 40 is not in use (e.g., during transport of the form). This helps to prevent the ties from being separated from the forms and becoming lost.

Optionally, pick-up loops 60 can be threaded into corresponding holes in the strongbacks 15, 25 to facilitate lifting the forms by means of a crane, hoist or forklift. This is shown in more detail in FIG. 10a. Other examples of the pick-up loops 60 are depicted in FIGS. 1-3, 6, 9 and 10.

FIG. 3a is a side elevational view showing an embodiment of the upper and lower forms 10, 20 with form liners 12, 22 attached to their faces 11, 21. These form liners 12, 22 can be used to imprint graphic designs on the surfaces of the concrete barrier. For example, the form liners can be made of a thin layer of latex or a polymeric material bearing a design that is been bonded or attached with fasteners to the form faces 11, 21.

In use, the forms can be transported in a disassembled state to the construction site. The disassembled components of the forms are relatively compact and can be readily loaded, transported by truck, and unloaded at the construction site without the need for specialized equipment. At the construction site, the halves of the lower forms 20 are erected in place, and secured to one another by inserting taper ties 40 though the lower forms 20 and engaging the side-locks 50, as described above. If a series of lower forms 20 are needed, they can positioned in series with their lateral attachment angles 29 abutting. The lower forms 20 can then be attached to one another by securing the fasteners 50 to the lateral attachment angles 29 of the lower forms 20.

Similarly, the halves of the upper forms 10 are initially erected, and secured to one another by inserting taper ties 40 through the upper forms 10, and engaging the side-locks 50. The upper forms 10 can then be stacked atop the lower forms. The upper forms 10 are secured to the lower forms 20 by fasteners 50 that grip the attachment angles 18 and 28. The upper forms can also be secured in series to adjacent upper forms by fasteners that grip the abutting lateral attachment angles 19.

Please note that other sequences of assembly are possible. For example, the lower forms 20 could be assembled first, and then moved into place. In addition, each of the upper forms 10 could be assembled with one of the lower forms 20, and then connected in series with an adjacent pair of upper/lower forms.

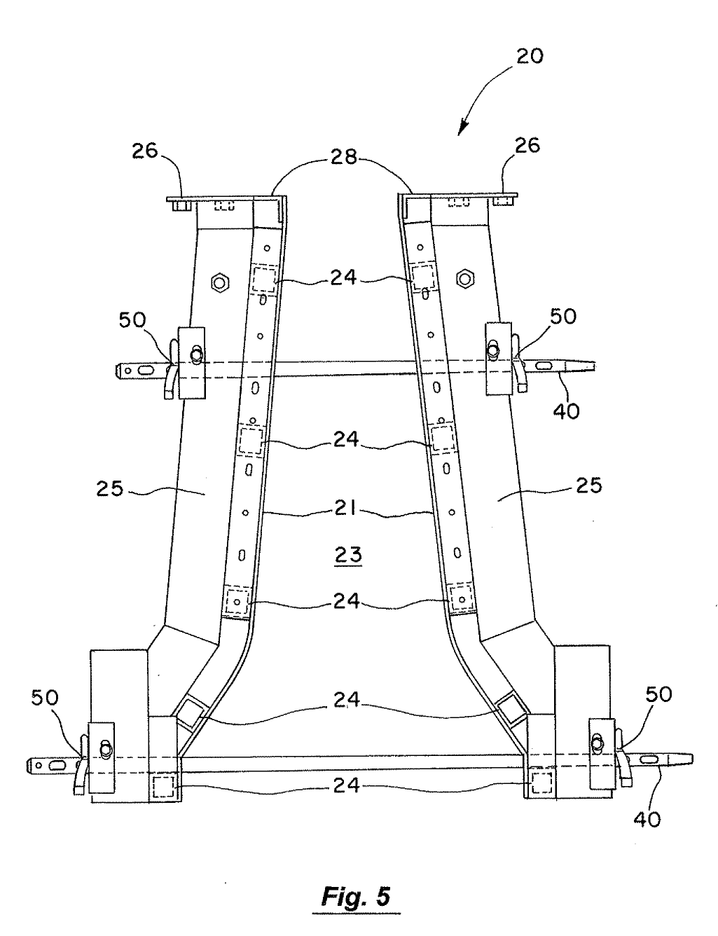

It should be noted that the modular nature of the halves of the upper and lower forms 10, 20 allows easy customization of the form cavity 13, 14 by substituting form faces 11 or 21 with different shapes or contours. For example, FIG. 5 is a vertical cross-sectional view of another embodiment of a lower form 20, in contrast to FIG. 4. In addition, the width of the form cavity 13, 14 can be changed by substituting ties 40 of a different length.

After assembly has been completed, concrete can be poured into the mold cavity 13, 23 to form a barrier. A period of time is required for the concrete to adequately set. After this has occurred, the taper ties 40 are released from the side locks 50 by rotating the side-lock handle 54 to withdraw the side-lock claw 56 from the hole 45 in the tie 40. The ties 40 can then be withdrawn through one side of the form. This typically requires exerting an axial force on the tie by striking a hammer on the small end of each taper tie 40. After the ties 40 have been removed, the form faces 11, 21 can be individually removed to reveal the finished concrete barrier 70. Cleaning is relatively straight-forward since all of the form faces 11, 21 are completely exposed after disassembly of the forms. The components can be readily loaded on a truck and transported to the next job site or to storage.

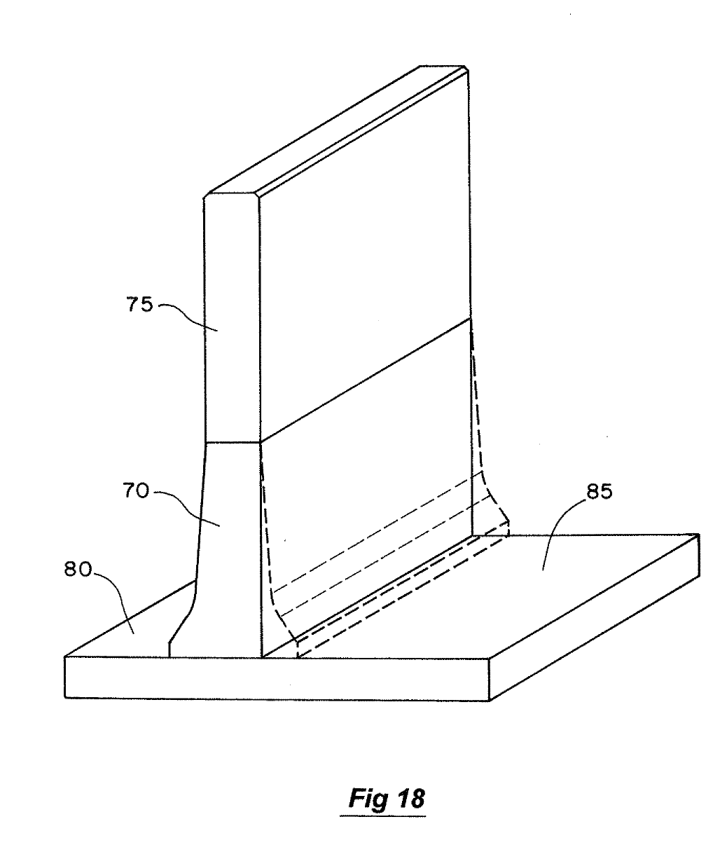

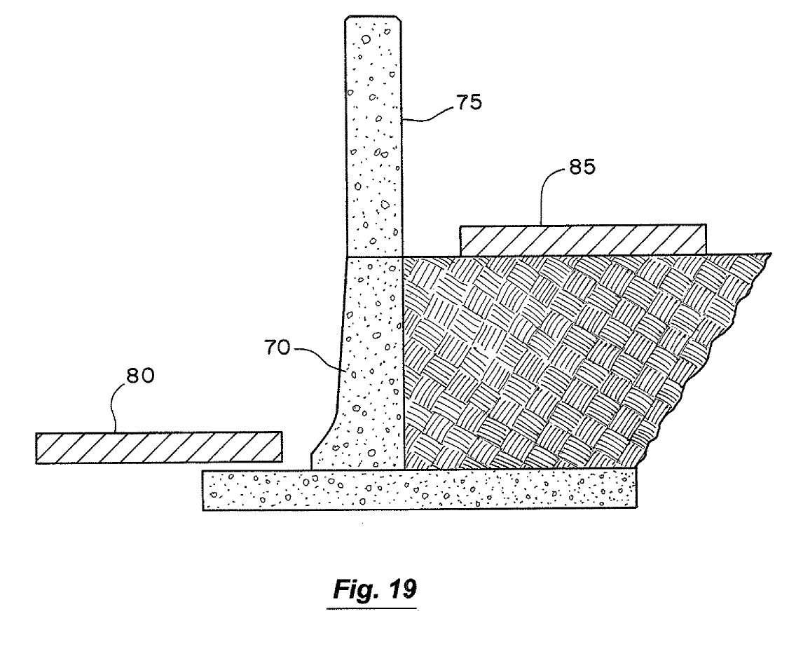

FIG. 18 is a perspective view of a finished concrete highway median barrier 70. For example, the upper section 75 of the barrier 70 can serve a sound barrier. FIG. 19 is a vertical cross-sectional view of another embodiment of a concrete highway median barrier 70 intended for use between roadbeds 80 and 85 at different elevations.

It should be expressly understood that forms of any required dimensions or proportions could be used. Also, any number of forms could be stacked to atop one another to create a barrier of any desired height. In addition, any number of forms can be combined in series to create a barrier of any desired length.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A modular form for casting concrete highway barriers comprising:
a lower form having:
(a) opposing lower faces with top and lateral edges, said lower faces being spaced apart to define a lower mold cavity;
(b) ties removably extending through the lower faces and lower mold cavity; and
(c) attachment angles extending along at least a portion of the top edges of the lower faces;
an upper form having:
(a) opposing upper faces with bottom and lateral edges, said upper faces being spaced apart to define an upper mold cavity;
(b) ties removably extending through the upper faces and upper mold cavity; and
(c) attachment angles extending along at least a portion of the bottom edges of the upper faces; and
fasteners removably securing the attachment angles of the lower form to the attachment angles of the upper form with the upper form stacked atop the lower form, and the upper mold cavity vertically aligned above the lower mold cavity to create a combined cavity for forming a concrete barrier.

2. The form of claim 1 further comprising a form liner attached to at least one of the faces for imprinting a design on the concrete barrier.

3. The form of claim 1 further comprising:
lateral attachment angles extending along at least a portion of the lateral edges of the faces of the upper and lower forms; and
fasteners for removably securing lateral attachment angles to the lateral attachment angles of an adjacent form.

4. The form of claim 1 further comprising a plurality of vertical lower strongbacks structurally supporting the lower faces and having upper ends, and a plurality of vertical upper strongbacks structurally supporting the upper faces and having lower ends removably attachable to the upper ends of the lower strongbacks.

5. The form of claim 1 wherein at least one of the ties extending through the lower form comprises a taper tie.

6. The form of claim 1 wherein at least one of the ties extending through the upper form comprises a taper tie.

7. The form of claim 1 wherein at least one of the fasteners comprises:
an anchor pin rotatably mounted to an attachment angle;
an arm extending from the anchor pin and having a distal end; and
a U-shaped clamp on the distal end of the arm for gripping the attachment angles of the upper form and lower form.

8. A modular form for casting concrete highway barriers comprising:
a lower form having:
(a) opposing lower faces with top and lateral edges, said lower faces being spaced apart to define a lower mold cavity;
(b) ties removably extending through the lower faces and lower mold cavity;
(c) a plurality of vertical strongbacks structurally supporting the lower faces and having upper ends; and
(d) attachment angles extending along at least a portion of the top edges of the lower faces;
an upper form having:
(a) opposing upper faces with bottom and lateral edges, said upper faces being spaced apart to define an upper mold cavity;
(b) ties removably extending through the upper faces and upper mold cavity;
(c) a plurality of vertical strongbacks structurally supporting the upper faces and having lower ends removably secured to the upper ends of the strongbacks of the lower form; and
(d) attachment angles extending along at least a portion of the bottom edges of the upper faces; and
fasteners removably securing the attachment angles of the lower form to the attachment angles of the upper form with the upper form stacked atop the lower form, and the upper mold cavity vertically aligned above the lower mold cavity to create a combined cavity for forming a concrete barrier.

9. The form of claim 8 further comprising a form liner attached to at least one of the faces for imprinting a design on the concrete barrier.

10. The form of claim 8 further comprising:
lateral attachment angles extending along at least a portion of the lateral edges of the faces of the upper and lower forms; and
fasteners for removably securing lateral attachment angles to the lateral attachment angles of an adjacent form.

11. The form of claim 8 wherein at least one of the ties extending through the lower form comprises a taper tie.

12. The form of claim 8 wherein at least one of the ties extending through the upper form comprises a taper tie.

13. The form of claim 8 wherein at least one of the fasteners comprises:
an anchor pin rotatably mounted to an attachment angle;
an arm extending from the anchor pin and having a distal end; and
a U-shaped clamp on the distal end of the arm for gripping the attachment angles of the upper form and lower form.

14. A modular form for casting concrete highway barriers comprising:
a lower form having:
(a) opposing lower faces with top and lateral edges, said lower faces being spaced apart to define a lower mold cavity;
(b) taper ties extending through the lower faces and lower mold cavity, said taper ties being removable through one of the lower faces to allow the faces to be disassembled from the finished concrete barrier; and
(c) attachment angles extending along at least a portion of the top edges of the lower faces;
an upper form having:
(a) opposing upper faces with bottom and lateral edges, said upper faces being spaced apart to define an upper mold cavity;
(b) taper ties extending through the upper faces and upper mold cavity, said taper ties being removable through one of the lower faces to allow the faces to be disassembled from the finished concrete barrier; and
(c) attachment angles extending along at least a portion of the bottom edges of the upper faces; and
fasteners removably securing the attachment angles of the lower form to the attachment angles of the upper form with the upper form stacked atop the lower form, and the upper mold cavity vertically aligned above the lower mold cavity to create a combined cavity for forming a concrete barrier.

15. The form of claim 14 further comprising a form liner attached to at least one of the faces for imprinting a design on the concrete barrier.

16. The form of claim 14 further comprising:
lateral attachment angles extending along at least a portion of the lateral edges of the faces of the upper and lower forms; and
fasteners for removably securing lateral attachment angles to the lateral attachment angles of an adjacent form.

17. The form of claim 14 wherein at least one of the fasteners comprises:
an anchor pin rotatably mounted to an attachment angle;
an arm extending from the anchor pin and having a distal end; and
a U-shaped clamp on the distal end of the arm for gripping the attachment angles of the upper form and lower form.

18. The form of claim 14 further comprising a plurality of vertical lower strongbacks structurally supporting the lower faces and having upper ends, and a plurality of vertical upper strongbacks structurally supporting the upper faces and having lower ends removably secured to the upper ends of the lower strongbacks.
